(19) United States
(12) Patent Application Publication
(10) Pub. No.: US 2015/0235063 A1
(43) Pub. Date: Aug. 20, 2015

(54) Object Identification Device with RFID Tag of Small Size

(71) Applicant: Tagsys, La Ciotat (FR)

(72) Inventor: Christophe Loussert, Aix en Provence (FR)

(73) Assignee: Tagsys, La Ciotat (FR)

(21) Appl. No.: 14/424,884

(22) PCT Filed: Aug. 27, 2013
(86) PCT No.: PCT/IB2013/058017

§ 371 Date: Feb. 27, 2015

Related U.S. Application Data
(60) Provisional application No. 61/694,032, filed on Aug. 28, 2012.

(51) Int. Cl. G06K 7/10

(52) U.S. Cl. CPC G06K 7/10316

(57) ABSTRACT

A device for the identification of at least one object includes at least one contactless RFID tag arranged in proximity to the object, the object being present on an object support or a rack, each tag containing an electronic chip and a magnetic antenna connected to the chip. The device also includes an electric antenna is present in the object support and is arranged in the latter in such a way as to establish electromagnetic coupling between the electric antenna and the magnetic antenna of the tag. Thus, the dimensions of the electric antenna, and particularly its length, are not then limited by the dimensions of the tag.

### TECHNICAL FIELD

The present invention relates to the field of electronic tags enabling contactless reading of an item of information and which are read remotely by a querying/reading/writing device emitting an electromagnetic field. The invention more particularly relates to a device for the identification of objects using magnetic RFID tags, said objects being arranged on a rack. The invention has a more particular application in traceability, tracking or management of objects of small size, such as jewellery arranged in a showcase. The contactless tags are information storage media of the RFID type, able to take various forms depending on the object to be identified. Additionally, the present invention is not limited to a particular form of the information storage medium.

### PRIOR ART

In the field of the management or tracking of objects by using electronic RFID tags, many tags of different sizes are found. In the case of objects of small dimensions, it is advantageous to use tags that are also of small dimensions so that the tag is not out of proportion with the object it identifies. This is for example the case for items of jewellery such as rings, watches or bracelets, where a tag surface of less than 2 or 3 square centimeters is generally desired. Then, use is conventionally made of essentially magnetic tags having the advantage of being relatively compact. A magnetic tag conventionally contains an electronic RFID chip connected to a magnetic antenna. The antenna is a magnetic coil (or a closed magnetic loop) capable of receiving or emitting the electromagnetic signals emitted by the querying/reading/writing device. For the sake of simplicity, in the remainder of the present description the term “RFID reader” will be used to denote such a querying/reading/writing device. Since the magnetic antenna is in the form of a closed loop, the tag thus occupies a smaller surface area.

However, these magnetic tags have a major drawback: their range is reduced. It is below 20 centimeters in the case of UHF electromagnetic signals. That constitutes a limitation when the articles are arranged on a rack in a showcase. To read their tags, the user is obliged to open the showcase to be able to bring the reader close enough for the magnetic antenna of the tag to pick up the electromagnetic signal emitted by the RFID reader.

To increase the range of the tags, it is known practice to add to the tag an electric antenna connected to the RFID chip having a length greater than the half-wavelength of the electromagnetic waves emitted by the RFID reader. However, that is only achieved by increasing the size of the tag, which is not desirable in the case of objects of small dimensions.

### SUMMARY OF THE INVENTION

The aim of the invention is to mitigate at least the aforementioned drawback, namely to propose a device for the identification of objects arranged on a support using RFID magnetic tags having a range greater than the known devices, without having to increase the size of the tags.

According to the invention, the device is complemented by an electric antenna with a long range that is arranged not on the RFID tag or on the object to be identified, but on the rack or tray acting as support for the object to be identified.

More particularly, the subject of the invention is a device for the identification of at least one object, said device comprising at least one contactless RFID tag arranged in proximity to said object, said object being present on an object support or rack or in a box, each tag containing an electronic chip and a magnetic antenna connected to said chip, said device furthermore comprising an electric antenna, wherein said electric antenna is present in the object support or box and is arranged in the latter in such a way as to establish electromagnetic coupling between the electric antenna and the magnetic antenna of the tag.

Thus, according to the invention, the electric antenna of the device is arranged not on the tag but in the support on which or in the box in which the objects to be identified are arranged. The dimensions of the antenna, and particularly its length, are then not limited to the dimensions of the tag.

According to an advantageous embodiment, the electric antenna is an electric dipole having a length that is an integer multiple of the half-wavelength of the electromagnetic signals intended for the electronic chip or a monopole dipole having a length that is an integer multiple of the quarter-wavelength of the signals. In the case of signals having a frequency of the order of 1 GHz, the wavelength is 30 cm and the length of the electric antenna is advantageously a multiple of 15 cm if the antenna is a dipole and a multiple of 7.5 cm if the antenna is a monopoleln a more general way, the electric antenna is an electric conductor acting as a radiofrequency booster. And its length is advantageously an integer multiple of the quarter-wavelength.

According to the invention, the magnetic antenna picks up the electromagnetic signals emitted by the RFID reader placed at a short distance from the tag, whereas the electric antenna picks up the electromagnetic signals emitted by the RFID reader when it is placed at a longer distance from the tag. When the electric antenna receives an electromagnetic signal, it then carries an electric current produced by the electric field of the received signal. The electric current generated is representative of the signal picked up by the electric antenna and this current in turn creates a magnetic field which is then picked up by the magnetic antenna of the tag.

According to a particular embodiment, the electric antenna is an approximately rectilinear conductive strip.

According to a variant embodiment, the electric antenna is an approximately rectilinear slot in a metallic plate.

Owing to its distinctive features, the invention makes it possible to use conventional magnetic tags of small dimensions to identify the objects and only the object support is modified by the implementation of the invention.

The invention also relates to an object support for a device as defined previously, comprising a plate on which are arranged a plurality of objects, each equipped with a contactless RFID tag, wherein said electric antenna is arranged on one of the surfaces, lower or upper, of the plate.

According to a particular embodiment, the plate is made of dielectric material and the electric antenna is an approximately rectilinear conductive strip arranged on the lower or upper surface of the plate.

According to an embodiment, the object support contains a plurality of cavities made in said plate and organized in rows to receive at least the tags of the objects, an electric antenna being arranged in proximity to at least one of the rows, along the length of this row, in such a way as to ensure electromagnetic coupling between the magnetic antenna of the tags of the objects and the electric antenna.

According to a particular embodiment, the electric antenna is arranged on the lower surface of the plate.

According to a particular embodiment, the electric antenna has a length that is an integer multiple n of the half-wavelength of the electromagnetic signals intended for the electronic chip and is arranged below said cavities. Advantageously, the cavities in one and the same row are arranged along the length of said electric antenna, above the latter, at points separated by a distance d from one of the two ends of the electric antenna, d being an odd multiple of a quarter-wavelength of the electromagnetic signals emitted by the RFID reader.

According to a particular embodiment, the depth of the cavities is approximately equal to the thickness of the plate in such a way that the tag placed in the cavity is tangential to the electric antenna.

### BRIEF DESCRIPTION OF THE FIGURES

Other advantages still may appear to those skilled in the art upon reading the examples below, which are illustrated by the appended figures and given by way of illustration:

FIG. 1 is a diagram of an RFID module of an electronic tag;

FIG. 2 is a schematic view of an item of jewellery equipped with an electronic tag;

FIG. 3 is a schematic view of the upper surface of a jewellery rack in accordance with the invention;

FIG. 4 is a schematic view of the lower surface of the rack in FIG. 3, said lower surface being equipped with electric antennas;

FIG. 5 is a diagram illustrating the operation of the device of the invention; and

FIG. 6 is a graph illustrating the read range of a tag reader reading a tag of the device of the invention as a function of the distance separating the electric antenna of the rack and the magnetic antenna of the electronic tag.

### DETAILED DESCRIPTION OF AT LEAST ONE EMBODIMENT

The invention will be described more particularly in the context of an application for managing items of jewellery, such as rings, said items of jewellery being arranged on a rack acting as support tray. These jewels are equipped with contactless RFID tags intended to be read by an RFID reader known per se.

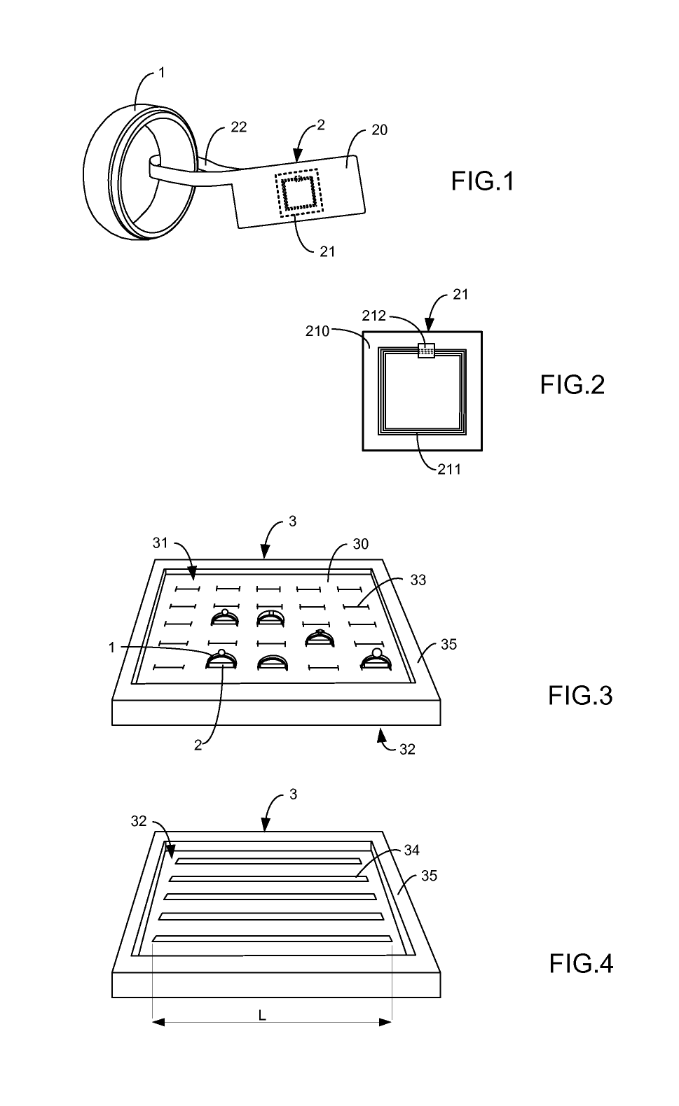

FIG. 1 shows a ring 1 equipped with a contactless RFID tag 2. The tag 2 comprises a paper support 20 in which is placed an RFID module 21 and means for fixing 22 the paper support to the item of jewellery. The fixing means are for example composed of a loop of paper surrounding a section of the ring as illustrated in FIG. 1.

In the context of the invention, the tag 2 is not necessarily fixed to the jewel. It is enough that it be placed in proximity to the jewel that it needs to identify.

As illustrated in FIG. 2, the RFID module 21 comprises a flexible support 210, of rectangular or square shape, made of dielectric material, having sides of 1 or 2 centimeters, for example, on which are arranged a coil of conductive material forming a magnetic antenna 211 and having two connection terminals and an electronic chip 212 connected to the terminals of the magnetic antenna. The magnetic antenna 211 and the electronic chip 212 are known per se and will not be described in more detail here.

According to the invention, the items of jewellery equipped with RFID tags are arranged on a rack 3, or a support tray as illustrated in FIG. 3 or in a box In the remainder of the present description, the terms “tray”, “rack” or “support” will be used interchangeably to denote the rack 3. With reference to FIG. 3, the rack is in the form of a plate 30 of rectangular shape having a given thickness. The plate 30 is produced from dielectric material. It contains an upper surface 31, a lower surface 32 and peripheral edges 35 projecting with respect to the two surfaces of the plate. The rack sits on the edges 34 when it is placed in a showcase.

The rack 3 comprises a plurality of cavities 33 intended to receive the tags and the items of jewellery. These cavities are organized in rows. In the example in FIG. 3, the rack contains 5 rows of 5 cavities 33. These cavities are slots made in the thickness of the plate and open on the upper surface of the plate. These slots may open onto the lower surface of the plate.

As illustrated by FIG. 3, the items of jewellery are partly introduced into these slots in such a way as to remain visible for potential purchasers. The tags enabling identification of the items of jewellery are also introduced at least partly into these slots in the rack. The tags are not necessarily fixed to the items of jewellery, but are placed beside the latter in the slots. In fact, according to the invention, it is not obligatory for the items of jewellery to be present in the slots, unlike the tags.

The lower surface 32 of the rack is shown in FIG. 4. According to an important feature of the invention, the rack 3 is equipped with wires or strips 34 made of conductive material. These wires or strips act as electric antennas for the RFID tags. These conductive strips are advantageously arranged on the lower surface 32 of the rack under the rows of cavities 33, preferably vertical to the latter. Advantageously, a conductive strip is provided for each row of cavities 33. The rack shown in FIGS. 3 and 4 thus contains 5 conductive strips 34 corresponding to the 5 rows of cavities. The length L of the strips 33 is advantageously an integer multiple of the half-wavelength of the electromagnetic signals emitted by the RFID reader. In the case of UHF signals having a frequency of 1 GHz, L is greater than or equal to 15 cm.

Advantageously, the cavities 33 in one and the same same row are arranged along the length of a conductive strip 34, above the latter, at points corresponding to a distance d′ with respect to one end of the conductive strip, d′ being an odd multiple of a quarter-wavelength of the electromagnetic signals intended for the electronic chip. In fact, at these points, the magnetic field generated by the conductive strip is at a maximum.

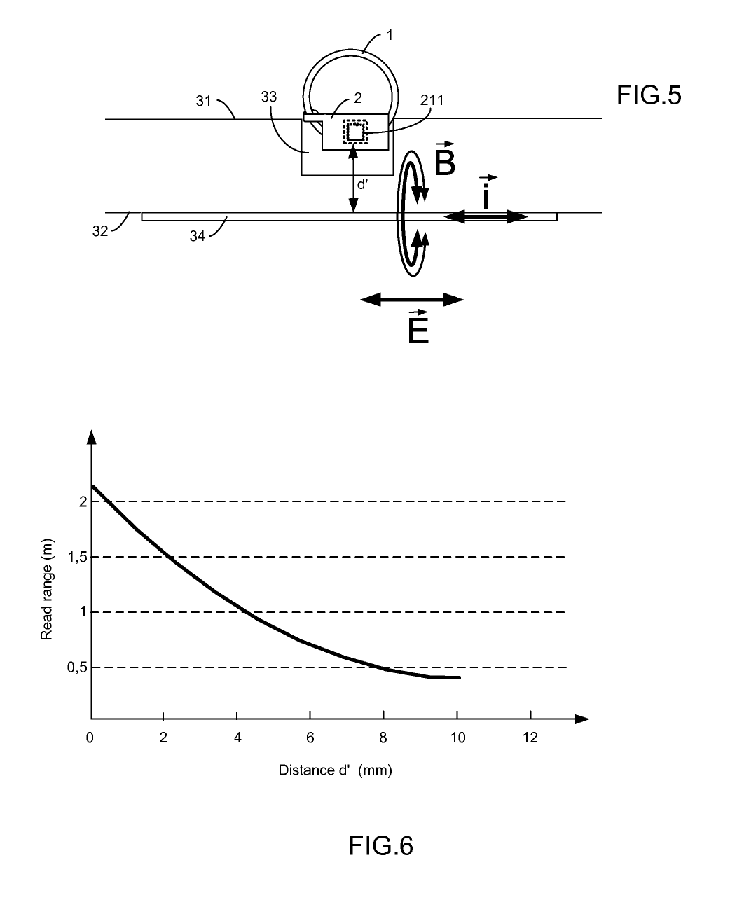

Thus, when the tag 2 is present in a cavity of the rack 3, the electric antenna 34 is situated at a distance d′ from the magnetic antenna 211 of the RFID module of the tag as illustrated in FIG. 5. This distance d′ is inversely proportional to the read range of the RFID reader. It is thus advantageously close to zero. The depth of the cavity 33 is thus preferably approximately equal to the thickness of the plate 30, so that the tag 2 introduced into the cavity may be arranged as close as possible to the electric antenna 34. The tag 2 is then positioned tangentially to the electric antenna 34 so that the electromagnetic coupling between the magnetic antenna of the tag and the electric antenna of the support is optimal.

The device operates in the following manner when the tag (and possibly the item of jewellery) is arranged in a cavity of the rack. If the RFID reader is positioned at a short distance (a distance of less than around 0.1 meter), the two antennas of the device, namely the magnetic antenna 211 and the electric antenna 34, pick up the electromagnetic signals emitted by the RFID reader. The magnetic antenna 211 picks up the magnetic field B of the electromagnetic signals and transmits a current i that is representative of this field B to the electronic chip 212. In the same way, the electric antenna 34 in proximity to the item of jewellery picks up the electric field E of the electromagnetic signals. The antenna 34 is then an electric dipole that is subject to a variable electric field. The antenna 34 then carries a current i that is representative of this field E. In response, the circulation of a current i in the dipole creates a magnetic field which is then picked up by the magnetic antenna 211 arranged nearby.

If the RFID reader is positioned at a greater distance of between 0.1 meter and around 2 meters, only the electric antenna 34 is capable of picking up the electromagnetic signals emitted by the RFID reader. The antenna 34 then carries a current i that is representative of the field E that it receives. The antenna 34 then carries a current i as explained previously. The antenna 34 then generates a magnetic field which is picked up by the magnetic antenna 211 arranged nearby.

The read range of the RFID reader varies as a function of the distance d′ between the magnetic antenna 211 and the electric antenna 34 as illustrated in FIG. 6. The shorter the distance d′, the stronger the electromagnetic coupling between the magnetic antenna and the electric antenna will be and the longer the read range of the tag will be. It is therefore advantageous to correctly position the tag in the cavity of the rack so that the distance d′ is as short as possible.

Thus, according to the invention, when the tag (and possibly the item of jewellery) is placed in the rack, the read range of the tag may reach several meters. It is around 2 meters for electromagnetic signals at a frequency of 1 GHz as shown in FIG. 6. It then becomes possible to use the RFID tags to take a quick inventory of the items of jewellery present in the store without having to open the showcases in which the items of jewellery are arranged on their racks. This device also makes it possible to locate a particular item of jewellery very quickly among the collection of jewellery presented in the showcases.

As soon as the tag is withdrawn from the rack, the RFID reading is still possible but the range is reduced to ten or so centimeters. Only the magnetic antenna 211 of the tag is then used to pick up the electromagnetic signals emitted by the RFID reader. The tag may then be read whatever its orientation.

In an advantageous embodiment, Split Ring Resonators (SRR) or other metamerials can be added between the metallic strips 34. The use of such SRRs makes it possible to reduce the lengths of the strips with the same results.

Of course, the device of the invention may be used for the tracking or management of objects other than jewellery and arranged on a rack, for example spectacles.

In the case of objects comprising a closed conductive loop, such as a ring, that is likely to interfere with the closed conductive loop of the magnetic antenna, it is advisable to arrange the object and/or the tag in the rack in such a way that the loop surface of the magnetic antenna straddling the loop surface of the object is less than 50% of the loop surface of the magnetic antenna. This may be achieved by sinking the electronic tag more deeply into the cavity than the object.

In a variant, the support or tray can be equipped with an energy sensor in order to provide energy to the RFID tag of the object and to increase the read range of the objects. In this case, the RFID tag is an active tag and the tray is equipped with contacts to connect the energy sensor or a battery energized by the energy sensor to the RFID tag. The energy sensor can be for example a photovoltaic cell.

This energy sensor can also be used for energizing, directly or via a battery, a price label.

Although the invention has been described in connection with a particular embodiment, it is obvious that it is in no way limited thereto and that it comprises all the technical equivalents of the means described as well as their combinations, if the latter fall within the scope of the invention.

As a variant, the electric antenna is in the form of a slot in a metallic plate, the slot length being advantageously greater than or equal to a half-wavelength of the electromagnetic signals used for the RFID reading. The rack is then equipped on its lower surface with a metallic plate provided with rectilinear slots positioned vertically with respect to the rows of cavities.

The device of the invention can also be used for identifying objects, like bottles, in a support like a box. The box is equipped with at least one electric antenna and the objects are each equipped with a RFID tag. If the box is designed for containing a plurality of objects, it preferably comprises one electric antenna for each object in the box. If the box comprises compartments each receiving an object, each compartment is equipped with an electric antenna. The electric antenna is for example printed on the wall of the compartment. When the object is present in a compartment, the magnetic antenna of the tag is sufficiently close to the electric antenna such that an electromagnetic coupling between the electric antenna and the magnetic antenna is established.

1-13. (canceled)

14. A device for the identification of at least one object comprising:
at least one contactless RFID tag arranged in proximity to the object, the object being present on an object support or in a box, each tag containing an electronic chip and a magnetic antenna connected to the chip; and
at least one electric antenna that is present in the object support or box and is arranged in such a way as to establish electromagnetic coupling between the electric antenna and the magnetic antenna of the tag.

15. The device of claim 14 wherein the electric antenna has a length that is an integer multiple of the quarter-wavelength of the electromagnetic signals intended for the electronic chip.

16. The device of claim 15 wherein the electric antenna is an electric dipole having a length that is an integer multiple of the half-wavelength of the electromagnetic signals intended for the electronic chip.

17. The device of claim 15 wherein the electric antenna is an electric monopole having a length that is an integer multiple of the quarter-wavelength of the electromagnetic signals intended for the electronic chip.

18. The device of claim 14, wherein the electric antenna is an approximately rectilinear conductive strip.

19. The device of claim 14 wherein the electric antenna is an approximately rectilinear slot in a metallic plate.

20. The device of claim 14 wherein the includes a plate on which are arranged a plurality of objects, each equipped with a contactless RFID tag, wherein the electric antenna is arranged on one of an upper or lower surface of the plate.

21. The device of claim 20 wherein the plate is made of dielectric material and the electric antenna is an approximately rectilinear conductive strip arranged on the lower or upper surface of the plate.

22. The device of claim 20 wherein it contains a plurality of cavities made in the plate and organized in rows to receive at least the tags of the objects, an electric antenna being arranged in proximity to at least one of the rows, along the length of this row, in such a way as to ensure electromagnetic coupling between the magnetic antenna of the tags of the objects and the electric antenna.

23. The device of claim 20 wherein the electric antenna is arranged on the lower surface of the plate.

24. The device of claim 22 wherein the electric antenna has a length that is an integer multiple n of the half-wavelength of the electromagnetic signals intended for the electronic chip and is arranged below the cavities.

25. The device of claim 24 wherein the cavities in one and the same row are arranged along the length of the electric antenna, above the latter, at points separated by a distance d from one of the two ends of the electric antenna, d being an odd multiple of a quarter-wavelength of the electromagnetic signals intended for the electronic chip.

26. The device of claim 24, wherein the depth of the cavities is approximately equal to the thickness of the plate in such a way that the tag placed in the cavity is tangential to the electric antenna.
